(19) United States
(12) Patent Application Publication
(10) Pub. No.: US 2025/0121491 A1
(43) Pub. Date: Apr. 17, 2025

(54) SYSTEM AND METHOD FOR ASSEMBLING ONBOARD CHARGER ASSEMBLY FOR ELECTRIFIED VEHICLE

(71) Applicant: FCA US LLC, Auburn Hills, MI (US)

(72) Inventors: Dawei Li, Shanghai (CN); Zhongwei Lu, Shanghai (CN); Yi Ju, Shanghai (CN); Xujing Ling, Shanghai (CN); Chunmei Fan, Shanghai (CN)

(21) Appl. No.: 18/485,366

(22) Filed: Oct. 12, 2023

(51) Int. Cl. B25J 9/00; B60L 53/22

(52) U.S. Cl. CPC B25J 9/0087; B60L 53/22

(57) ABSTRACT

A system for assembling an onboard charger (OBC) for an electrified vehicle according to the present disclosure includes a tooling head, a first manipulator, and a second manipulator. The tooling head is coupled for movement with a robotic arm assembly. The first manipulator is coupled to a first arm extending from the tooling head and is configured to engage a first printed circuit board assembly (PCBA). The second manipulator is coupled to a second arm extending from the tooling head and is configured to engage a second PCBA. The first and second manipulators are configured to move the first and second PCBA's onto distinct sides of the OBC while the OBC remains static.

### FIELD

The present application generally relates to electrified vehicles and, more particularly, to a system and related method for assembling an onboard charger assembly for an electrified vehicle.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery packs. Typically, the battery pack assembly is charged using an onboard charger assembly. Many onboard charger assemblies include a housing having a printed circuit board assembly (PCBA) disposed thereon. Some onboard charger assemblies include housings having two PCBA's disposed thereon. Such examples typically are assembled at a PCBA loading station having a sequence of assembling stations. For example, a first PCBA is coupled or affixed to one side of the housing and a second PCBA is coupled or affixed to an opposite side of the housing. In prior art examples, a manipulator locates the first PCBA onto the housing at a subsequent assembling station. In some examples, once the first PCBA is coupled to the housing, the housing is rotated 180 degrees. Next, the second PCBA is located onto the second side of the housing, with a second manipulator at another station, before being coupled thereto. Installation of PCBA's onto the housing therefore requires several process stations and high production time and investment. Accordingly, while such conventional processes for assembling PCBA's to housings of onboard chargers do work well for their intended purpose, there exists an opportunity for improvement in the relevant art.

### SUMMARY

According to one example aspect of the invention, a system for assembling an onboard charger (OBC) for an electrified vehicle includes a tooling head, a first manipulator, and a second manipulator. The tooling head is coupled for movement with a robotic arm assembly. The first manipulator is coupled to a first arm extending from the tooling head and is configured to engage a first printed circuit board assembly (PCBA). The second manipulator is coupled to a second arm extending from the tooling head and is configured to engage a second PCBA. The first and second manipulators are configured to move the first and second PCBA's onto distinct sides of the OBC while the OBC remains static.

In some implementations, the first and second manipulators are configured to move concurrently while locating the first PCBA onto a first receiving surface of the OBC and the second PCBA onto a second receiving surface of the OBC. The first receiving surface is on an opposite side of the OBC as the second receiving surface.

According to another example aspect of the invention, the first and second manipulators are configured to move sequentially while locating the first PCBA onto a first receiving surface of the OBC and the second PCBA onto a second receiving surface of the OBC.

In some implementations, the first manipulator further includes a first leg that extends from the manipulator, the first leg movably attached to the manipulator. The first leg is configured to move relative to the manipulator to accommodate a PCBA having a distinct size.

In additional arrangements the first manipulator further includes a first track defined therein, wherein the first leg is configured to translate along the first track. The first manipulator further comprises a second, third and fourth leg that extend from the manipulator, wherein each of the second third and fourth leg are configured to move relative to the manipulator to accommodate a PCBA having a distinct size. The first leg further includes a first toot at a distal end thereof. The first foot is configured to engage the first PCBA.

According to another example aspect of the invention, a method of assembling an on board charger (OBC) for an electrified vehicle is provided. The method includes engaging a first printed circuit board assembly (PCBA) with a first manipulator extending from a tooling head coupled for movement with a robotic arm assembly. A second PCBA is engaged with a second manipulator extending from the tooling head. The first and second PCBA's are advanced with the respective manipulators onto distinct first and second sides of the OBC while the OBC remains static.

In additional arrangements, the method further includes coupling the first PCBA to the first side of the OBC and coupling the second PCBA to the second side of the OBC. The first and second sides are opposite sides of the OBC.

According to another example aspect of the invention, advancing the first and second PCBA's includes concurrently advancing the first and second PCBA's while locating the first PCBA onto a first receiving surface of the OBC and the second PCBA onto a second receiving surface of the OBC.

In some implementations, advancing the first and second PCBA's includes sequentially advancing the first and second PCBA's while locating the first PCBA onto a first receiving surface of the OBC and the second PCBA onto a second receiving surface of the OBC.

In examples, engaging the first PCBA includes engaging the first PCBA with a first leg extending from the first manipulator. The method further include moving the first leg relative to the first manipulator into a desired position to engage the first PCBA.

In some implementations, moving the first leg includes advancing the first leg along a first track defined in the first manipulator. In other examples, engaging the first PCBA includes engaging the first PCBA with a second, third and fourth leg extending from the first manipulator. The method can further include moving at least one of the second, third and fourth leg relative to the first manipulator into a position suitable for engaging the first PCBA.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including an onboard charging assembly according to the principles of the present application;

FIG. 2 is an exemplary assembly sequence of assembling first and second PCBA's onto a housing of an onboard charging assembly according to one Prior Art example;

FIG. 3A is a side perspective view of first and second PCBA's being initially aligned for receipt onto first and second respective sides of a housing by first and second manipulators of a robotic arm assembly according to the principles of the present application;

FIG. 3B is a side perspective view of the first and second PCBA's of FIG. 3A being advanced onto the first and second respective sides of a housing by the first and second manipulators of a robotic arm assembly according to the principles of the present application;

FIG. 4A is a detail perspective view of the first manipulator of FIG. 3B according to principles of the present application; and

FIG. 4B is a detail perspective view of the second manipulator of FIG. 3B according to principles of the present application.

### DESCRIPTION

As discussed above, many onboard charger assemblies used for electrified vehicles include a housing having a printed circuit board assembly (PCBA) disposed thereon. Some onboard charger assemblies include housings having two PCBA's disposed thereon. Such examples typically are assembled at a PCBA loading station having a sequence of assembling stations. Installation of two PCBA's onto the housing therefore requires several process stations and high production time and investment.

Accordingly, the instant disclosure provides a system for assembling PCBA's onto a housing with reduced production time and complexity. The instant system includes two PCBA manipulators that are integrated onto a tooling head. The tooling head is coupled for movement by a robotic arm assembly. The robotic arm moves the tooling head to receive the two PCBA's at a PCBA feeding area. The two PCBA manipulators pick up the PCBA's separately or simultaneously from the PCBA feeding area. The robotic arm then moves the tooling head with the two PCBA's on the gripper legs to the onboard charger (OBC) housing. The two manipulators on the tooling head can separately or simultaneously load and release the PCBA's from the gripper legs onto both sides of the OBC housing.

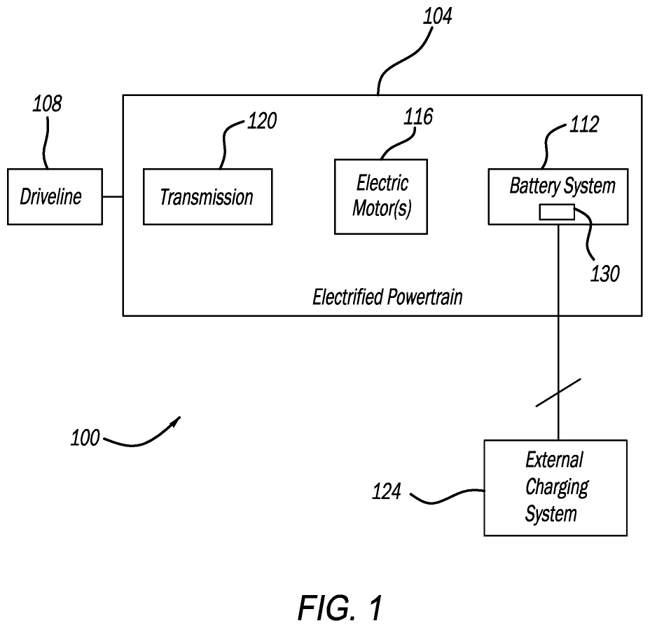

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “external charger 124”) for charging of the battery system 112. The battery system 112 includes an onboard charger 130 that assists in providing a charging input to the battery system.

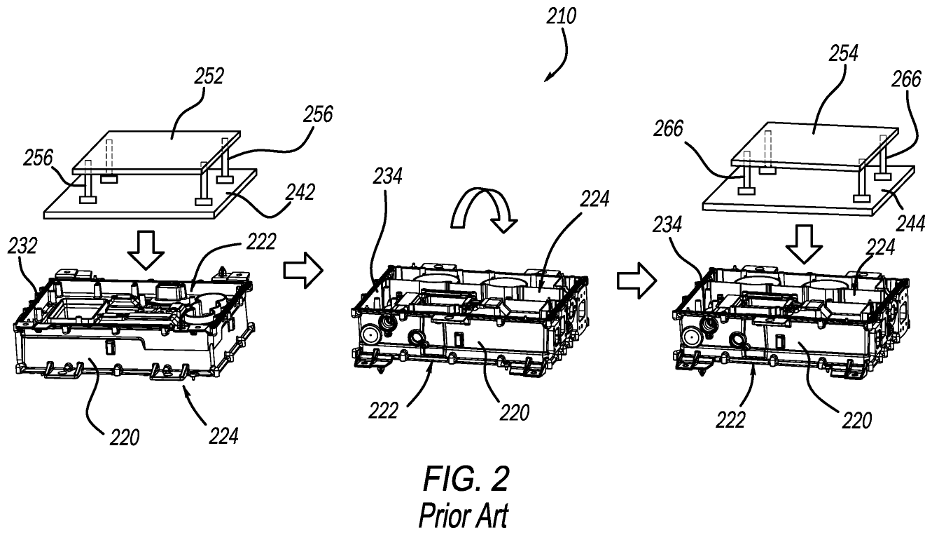

Referring now to FIG. 2, an exemplary assembly system for assembling first and second PCBA's onto a housing of an onboard charging assembly according to one Prior Art example is shown and generally identified at reference numeral 210. The system 210 according to the Prior Art example shown generally includes a OBC housing 220 having a first side 222 and a second side 224. In the example shown, the first and second sides 222 and 224 are on opposite sides of the OBC housing 220. The first side 222 generally includes a first receiving surface 232 configured to receive a first PCBA 242. The second side 224 generally includes a second receiving surface 234 configured to receive a second PCBA 244.

In one exemplary prior art assembling sequence the OCB housing 220 is positioned such that the first receiving surface 232 is upright and aligned for receipt of the first PCBA 242. Next, a first manipulator 252 that engages the first PCBA 242 with legs 256 advances the first PCBA 242 onto the first receiving surface 232. The first PCBA 242 can then be secured to the first receiving surface 232 using any desired coupling method.

Next, the OBC housing 220 is rotated into an inverse position, such as rotated 180 degrees to orient the second receiving surface 234 of the second side 224 in the upright position for receipt of the second PCBA 244. Next, a second manipulator 254 that engages a second PCBA 244 with legs 266 advances the second PCBA 244 onto the second receiving surface 234. The second PCBA 244 can then be secured to the second receiving surface 234 using any desired coupling method. In prior art examples, the first manipulator 252 has legs 256 sized specifically to engage a specific PCBA 242. Similarly, the second manipulator 254 has legs 266 sized specifically to engage a specific PCBA 244. In other words, the manipulators 252 and 254 are not selectively configurable to easily modify to cooperate with other PCBA's having other geometries. If PCBA's with different sizes are used, different PCBA manipulators are required. The flexibility of the Prior Art system 210 therefore is limited.

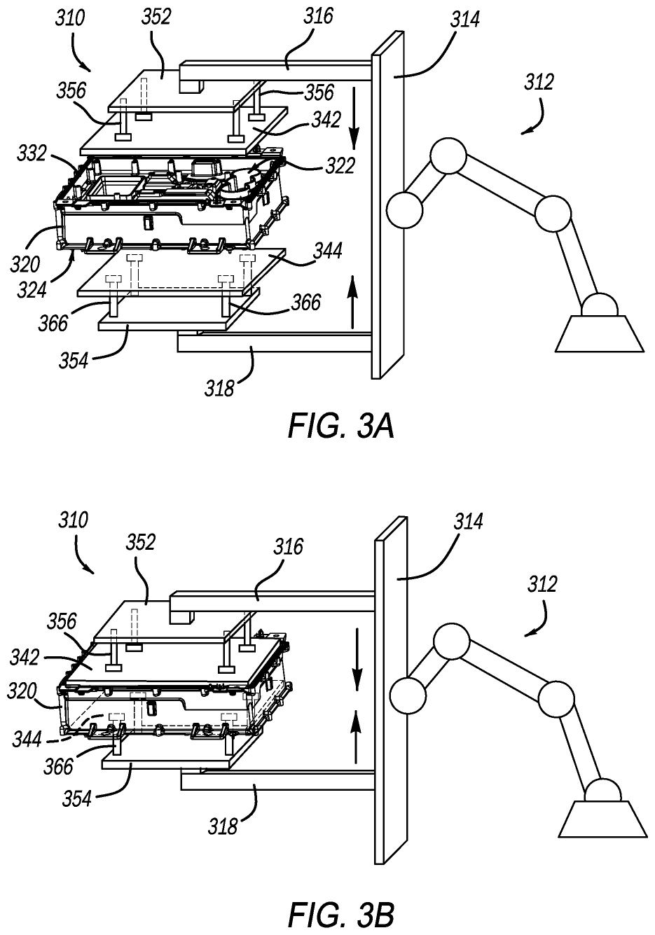

Turning now to FIGS. 3A and 3B a system for installing first and second PCBA's onto a housing of an OBC according to the present disclosure is shown and generally identified at reference 310. The system 310 generally includes a robotic arm assembly 312, a tooling head 314, a first arm 316 and a second arm 318. As will be described herein, the first and second arms 316, 318 can advance concurrently or sequentially to move the respective PCBA's onto the housing into an installed position.

An OBC housing 320 (also referred to herein as simply “OBC”) has a first side 322 and a second side 324. In the example shown, the first and second sides or surfaces 322 and 324 are on opposite sides of the OBC housing 320. The first side 322 generally includes a first receiving surface 332 configured to receive a first PCBA 342. The second side 324 generally includes a second receiving surface 334 configured to receive a second PCBA 344.

In one example method of using the system 310, the robotic arm assembly 312 moves the tooling head 314 to receive the two PCBA's 342, 344 at a PCBA feeding area (not specifically shown). Two PCBA manipulators 352, 354 coupled to the respective arms 316, 318 pick up the PCBA's 342, 344 separately or simultaneously such as from a PCBA feeding area. In examples, the manipulators 352 and 352 grasp the respective PCBA's 342 and 344 with legs 356 and 366 associated with the respective manipulators 352, 354. The robotic arm assembly 312 then moves the tooling head 314 with the two PCBA's 342, 344 on the gripper legs 356, 366 to the OBC housing 320. The two manipulators 352, 354 on the tooling head 314 can separately or simultaneously load and release the PCBA's 342, 344 from the gripper legs 356, 366 onto both sides 322, 324 of the OBC housing 320 (FIG. 3B). Notably, the housing 320 can remain in a fixed or static position and does not need to be rotated.

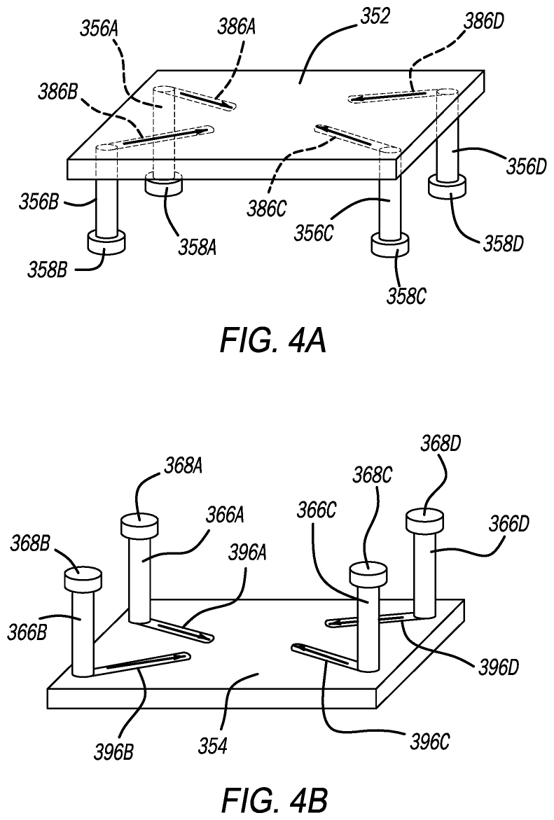

With reference now to FIGS. 4A and 4B, additional features of the instant application will be further described. The manipulators 352 and 354 can be configured to adjust a position of the respective legs 356, 366 automatically to accommodate PCBA's having different sizes. Explained further, the legs 356, identified individually at 356A, 356B, 356C and 356D can ride along tracks 386A, 386B, 386C and 386D provided on the manipulator 352. While tracks are shown, it is appreciated that the legs 356A, 356B, 356C and 356D can be configured to move relative to the manipulator 352 using other configurations within the scope of this disclosure. Each leg 356A, 356B, 356C and 356D has a respective foot 358A, 358B, 358C and 358D extending at a distal end that is configured to interface with the PCBA 342.

Similarly, the legs 366, identified individually at 366A, 366B, 366C and 366D can ride along tracks 396A, 396B, 396C and 396D provided on the manipulator 354. While tracks are shown, it is appreciated that the legs 366A, 366B, 366C and 366D can be configured to move relative to the manipulator 354 using other configurations within the scope of this disclosure. Each leg 366A, 366B, 366C and 366D has a respective foot 368A, 368B, 368C and 368D extending at a distal end that is configured to interface with the PCBA 344.

In many advantages of the system 310 described herein, the production time of the OBC assembly is optimized. Machine quantity and line size of the OBC assembly line can be reduced. Flexibility and compatibility of the PCBA loading station for different types of PCBA's with different sizes is increased.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A system for assembling an onboard charger (OBC) for an electrified vehicle, the system comprising:
a tooling head coupled for movement with a robotic arm assembly;
a first manipulator coupled to a first arm extending from the tooling head, the first manipulator configured to engage a first printed circuit board assembly (PCBA);
a second manipulator coupled to a second arm extending from the tooling head, the second manipulator configured to engage a second PCBA; and
wherein the first and second manipulators are configured to move the first and second PCBA's onto distinct sides of the OBC while the OBC remains static.

2. The system of claim 1, wherein the first and second manipulators are configured to move concurrently while locating the first PCBA onto a first receiving surface of the OBC and the second PCBA onto a second receiving surface of the OBC.

3. The system of claim 2, wherein the first receiving surface is on an opposite side of the OBC as the second receiving surface.

4. The system of claim 1, wherein the first and second manipulators are configured to move sequentially while locating the first PCBA onto a first receiving surface of the OBC and the second PCBA onto a second receiving surface of the OBC.

5. The system of claim 1, wherein the first manipulator further comprises:
a first leg that extends from the manipulator, the first leg movably attached to the manipulator, wherein the first leg is configured to move relative to the manipulator to accommodate a PCBA having a distinct size.

6. The system of claim 5, wherein the first manipulator further includes a first track defined therein, wherein the first leg is configured to translate along the first track.

7. The system of claim 6, wherein the first manipulator further comprises a second, third and fourth leg that extend from the manipulator, wherein each of the second third and fourth leg are configured to move relative to the manipulator to accommodate a PCBA having a distinct size.

8. The system of claim 5, wherein the first leg further includes a first foot at a distal end thereof, the first foot configured to engage the first PCBA.

9. A method of assembling an onboard charger (OBC) for an electrified vehicle, the method comprising:
engaging a first printed circuit board assembly (PCBA) with a first manipulator extending from a tooling head coupled for movement with a robotic arm assembly;
engaging a second PCBA with a second manipulator extending from the tooling head; and
advancing the first and second PCBA's with the respective first and second manipulators onto distinct first and second sides of the OBC while the OBC remains static.

10. The method of claim 9, further comprising:
coupling the first PCBA to the first side of the OBC; and
coupling the second PCBA to the second side of the OBC.

11. The method of claim 10, wherein the first side and the second side are opposite sides of the OBC.

12. The method of claim 10, wherein advancing the first and second PCBA's comprises:
concurrently advancing the first and second PCBA's while locating the first PCBA onto a first receiving surface of the OBC and the second PCBA onto a second receiving surface of the OBC.

13. The method of claim 9, wherein advancing the first and second PCBA's comprises:
sequentially advancing the first and second PCBA's while locating the first PCBA onto a first receiving surface of the OBC and the second PCBA onto a second receiving surface of the OBC.

14. The method of claim 9, wherein engaging the first PCBA includes engaging the first PCBA with a first leg extending from the first manipulator.

15. The method of claim 14, further comprising:
moving the first leg relative to the first manipulator into a desired position to engage the first PCBA.

16. The method of claim 15, wherein moving the first leg comprises:
advancing the first leg along a first track defined in the first manipulator.

17. The method of claim 14, wherein engaging the first PCBA includes engaging the first PCBA with a second, third and fourth leg extending from the first manipulator.

18. The method of claim 17, further comprising:
moving at least one of the second, third and fourth leg relative to the first manipulator into a position suitable for engaging the first PCBA.
